(19) United States
(12) Patent Application Publication
(10) Pub. No.: US 2018/0366750 A1
(43) Pub. Date: Dec. 20, 2018

(54) METHOD FOR CONTROLLING A FUEL CELL

(71) Applicant: COMPAGNIE GENERALE DES ETABLISSEMENTS MICHELIN, Clermont-Ferrand (FR)

(72) Inventors: Vincent Braillard, Clermont-Ferrand Cedex 9 (FR); Gino Paganelli, Clermont-Ferrand Cedex 9 (FR)

(73) Assignee: COMPAGNIE GENERALE DES ETABLISSEMENTS MICHELIN, Clermont-Ferrand (FR)

(21) Appl. No.: 16/061,178

(22) PCT Filed: Dec. 9, 2016
(86) PCT No.: PCT/FR2016/053292

§ 371 Date: Jun. 11, 2018

(30) Foreign Application Priority Data
Dec. 11, 2015 (FR) 1562206

(51) Int. Cl. H01M 8/04537; H01M 8/04746; H01M 8/04089; H01M 8/1018

(52) U.S. Cl. CPC H01M 8/04589; H01M 8/04753; H01M 8/04626; H01M 2250/20; H01M 8/1018; H01M 2008/1095; H01M 8/04097

(57) ABSTRACT

The disclosure relates to a method for controlling a polymer electrolyte membrane fuel cell. The fuel cell is installed in a system which comprises a fuel gas supply circuit that links a fuel gas reservoir to the anode of the fuel cell. The system also has an oxidant gas supply circuit linking an oxidant gas reservoir, or atmospheric air. The method includes the step of supplying the fuel cell with oxidant gas. The method proceeds with the step of detecting that the current produced by the cell is greater than a first threshold determined on the basis of the system in which the fuel cell is installed. The method continues with the step of reducing the supply of oxidant gas to the fuel cell in order to reduce the current that is produced.

### CROSS-REFERENCE TO RELATED APPLICATION

The present application claims priority to PCT International Patent Application Serial No. PCT/FR2016/053292, filed Dec. 9, 2016, entitled “METHOD FOR CONTROLLING A FUEL CELL,” which claims the benefit of FR Patent Application Serial No. 1562206, filed Dec. 11, 2015.

### BACKGROUND OF THE INVENTION

### 1. Field of the Invention

The present invention relates to fuel cells and in particular, but not exclusively, to fuel cells in which the electrolyte takes the form of a polymer membrane (that is to say of PEFC (polymer electrolyte fuel cell) type).

More precisely, the present invention relates to the operation of a fuel cell when it is used in a vehicle in combination with another power source.

### 2. Related Art

It is known that fuel cells make it possible to generate electric power directly through an electrochemical redox reaction, from a fuel gas and an oxidant gas, without an intermediate conversion into mechanical energy. This technology seems promising for automotive applications in particular.

The operating point of a fuel cell, in terms of electric power that is delivered, is normally defined by the charge that is applied to it. Thus, for correct operation of a vehicle equipped with a fuel cell, it is useful for the cell, when it is installed in an overall supply system, to be linked to an electronic converter that makes it possible to vary the impedance seen by the fuel cell, and therefore its operating point. Specifically, to meet the power demand from the driver, expressed via the acceleration pedal of the vehicle, it is necessary to be able to adjust the power supplied by the cell, through a modification of its operating point. It is specified at this juncture that when reference is made to ‘variation of the operating point’, this means a variation in the magnitude of the current leaving the fuel cell: I PAC.

What are termed ‘full H2’ vehicle architectures, that is to say architectures without battery storage, are thus known, one example of this being shown in FIG. 1. In this example, an engine inverter 11 is installed between the fuel cell 10 and the engine 12. In this case, it is the inverter that makes it possible to adjust the impedance seen by the fuel cell, and therefore the operating point I PAC.

Electric vehicle architectures with a battery, fitted with a range extender, are also known. FIG. 2 illustrates an example of such an architecture, in which the engine 22 is supplied primarily by a battery 23. An inverter 21 is positioned between the battery 23 and the engine 21. This vehicle is fitted with a range extender in the form of a fuel cell 20 that makes it possible to recharge the battery 24 when the latter is discharged. In order to define the operating point I PAC, use is made of an electronic DC-to-DC voltage converter 23 installed between the fuel cell 20 and the battery 24.

However, this architecture exhibits several major drawbacks, as the converter 23 is a component that is expensive, heavy and bulky. Furthermore, using such a converter leads to a loss of efficiency, as the usual efficiency of a converter is of the order of 90% to 95%.

It has therefore been contemplated to remove this converter 23, thereby leading to direct coupling, in parallel, of the cell 20 and of the battery 24. Such coupling imposes constraints on the matching of the voltages of the two voltage generators, as the fuel cell and the battery have to have substantially identical voltage ranges in order to be able to be connected directly in parallel. Given that a battery has a virtually constant voltage, it is this voltage that will therefore be imposed de facto on the fuel cell.

Such a constraint exhibits two significant drawbacks. Firstly, the voltage variation range of the battery, which range is relatively small, does not make it possible to utilize a wide variation range of the operating point of the fuel cell. Specifically, the battery has a substantially constant voltage, and, given the direct coupling, it imposes its voltage on the fuel cell. The result of this is a current delivered by the fuel cell in accordance with its characteristic bias curve. In the example shown in FIG. 4, the battery has a voltage of 62 V. According to the bias curve taken as an example, the current supplied by the fuel cell will be 220 A. In practice, depending on the driver's demands, the voltage of the battery varies, thereby also leading to a variation of the current of the fuel cell. However, this voltage variation remains relatively small, and therefore does not make it possible to utilize a wide variation range of the operating point of the fuel cell.

Secondly, it proves impossible to reduce the current delivered by the fuel cell when the power demand from the engine is low, or the state of charge of the battery does not allow said current to be absorbed.

### SUMMARY OF THE INVENTION AND ADVANTAGES

The present disclosure therefore aims to propose a solution that makes it possible to rectify these two drawbacks.

A fuel cell is a stack of unitary elements that are each formed essentially of an anode and of a cathode that are separated by a polymer membrane that allows protons to pass from the anode to the cathode.

This stack is installed in a system comprising a fuel gas supply circuit linking a fuel gas reservoir to the anode of the fuel cell, and an oxidant gas supply circuit linking an oxidant gas reservoir, or atmospheric air.

The anode supplied with fuel, for example hydrogen, is where an oxidation half-reaction takes place. At the same time, the cathode supplied with oxidant, for example pure oxygen or oxygen contained in air, is where a reduction half-reaction takes place. It is these two half-reactions that lead to the production of water and of current.

As indicated above, the present disclosure aims to propose a solution for reducing the current produced by the fuel cell, when the engine demand is small, or when the state of charge of a battery linked to the fuel cell does not allow the current to be absorbed.

To this end, the disclosure relates to a method for controlling a polymer electrolyte membrane fuel cell, the fuel cell being installed in a system comprising a fuel gas supply circuit linking a fuel gas reservoir to the anode of the fuel cell, and an oxidant gas supply circuit linking an oxidant gas reservoir, or atmospheric air. The method comprises the following steps:

supplying the fuel cell with oxidant gas, also called oxidant,

detecting that the current produced by the cell is greater than a first threshold determined on the basis of the system in which the fuel cell is installed, and

reducing the supply of oxidant gas to the fuel cell in order to reduce the current that is produced.

More precisely, the amount of oxygen that is introduced is reduced in order to limit the current to the desired value in accordance with the stoichiometric relationship that linearly links the current that is produced and the amount of oxygen that is consumed for a given fuel cell. For example, for a fuel cell formed of 50 elementary cells, the oxygen consumed at 100 A is 17.5 standard litres per minute (SLPM). Therefore, in theory, if it is desired to limit the current to 100 A, the amount of air that is introduced will be reduced to 83 SLPM (17.5 SLPM/21%). In practice, some of the oxygen manages to escape from the cell without reacting, and it is therefore necessary to provide a slight oversupply with respect to the current that is desired. Advantageously, in one embodiment of the disclosure, use is made of a controller responsible for controlling the air flow rate in order to satisfy a current setpoint.

The disclosure is used to particular advantage in systems in which the fuel cell is coupled directly to another voltage generator, in particular a battery.

More specifically, the disclosure is used to particular advantage when the fuel cell is coupled to a load that is voltage-controlled and not current-controlled. Specifically, if the load coupled to the fuel cell is current-controlled, it would have a tendency to adjust its impedance so as to keep a constant current, which would lead to a voltage collapse in the elementary cell as there would not be enough air to sustain this current. In this mode of operation, it is therefore preferable for the load to operate in low-voltage limitation mode, so as not to bring about a voltage collapse in the fuel cell.

The disclosure is therefore particularly recommended when the fuel cell is coupled to another voltage generator. This thus naturally prevents any risk of a voltage collapse incurred in the event of an undersupply of air.

It is known that the oxygen consumed by a fuel cell is strictly proportional to the current that is produced, and it is defined by the following relationship:

$${\dot{m}}_{o 2} = \frac{{MW}_{o 2} \cdot Nb\_cell}{{n}_{{e}^{-}} \cdot F} \cdot {I}_{FC}$$

\dot{m}ₒ₂: Oxygen consumption [g/s]

ne−: Number of electrons=2

MWo2: molecular weight of oxygen

Nb_cell: Number of elementary cells in the cell

F: Faraday's constant [96487 Coulombs/mol]

IFC: Current in the cell [A]

Preferably, in a method according to the disclosure, the fuel cell is oversupplied with oxidant, that is to say that the cathode receives more oxygen than necessary in order to sustain the current delivered by the fuel cell. In one example, this oversupply is characterized by a stoichiometric ratio at the cathode set to around 2.

Such a value makes it possible to ensure good homogenization of the current over the active surface area of the elementary cells of the fuel cell, while at the same time avoiding saturation of the air at the cell outlet with water produced by the fuel cell.

Furthermore, it has been observed that a higher stoichiometric ratio is not desirable, as this could lead to a consumption that is parasitic for the air supply and to drying out of the membrane-electrode assemblies.

The disclosure thus proposes to undersupply the fuel cell with air when it is necessary to reduce the current produced by the cell. To this end, the supply of oxidant to the cell is reduced. Specifically, when there is no longer enough oxidant to sustain the level of current produced by the cell, said level decreases until it reaches the level corresponding to the amount of oxidant supplied. It is specified at this juncture that it is also possible to entirely cancel out the current produced by the fuel cell if the incoming air flow is completely cut off

The need to reduce the current produced by the cell arises in particular in the case where the fuel cell is linked to a battery, for example when the cell is used as a range extender for a system supplied by the battery. In this case, the detection of the need to reduce the current is performed on the basis of an estimation of the charge of the battery.

In another example, it may be necessary to reduce the current if an engine directly or indirectly supplied by the fuel cell demands a low power. In this case, the detection is performed on the basis of a measurement of the bus current.

Moreover, it has been observed, when implementing a control method according to the disclosure, that an undersupply of air to the fuel cell leads to an oversaturation in terms of humidity of the air leaving the cell, as the amount of air is no longer sufficient to avoid condensation of the water that is produced. This risks leading to phenomena of flooding of the fuel cell and therefore to malfunctioning of or damage to the cell. Furthermore, the undersupply of oxidant may bring about division of the active surface area into two areas, one area close to the air inlet producing the current and an oxygen-deprived zone that no longer produces current, see FIG. 5 described further on. In this case, the zone deprived of oxygen at the cathode but still supplied with hydrogen at the anode may behave as a proton pump, that is to say that it will transform into a current consumer for the zone that is still active, which current will be used to pump hydrogen from the anode to the cathode through the proton exchange membrane. This process is also known for the electrochemical compression of hydrogen. In our case, this would involve a reaction that would lead to parasitic consumption of current and also of hydrogen. In addition, the hydrogen pumped from the anode to the cathode is liable to react with the residual oxygen, and to produce heating by way of combustion, leading to a risk of damage to the elementary cells of the fuel cell. However, the latter reaction is unlikely as this zone is fittingly highly oxygen-depleted.

It therefore seems useful, in one preferred embodiment, to limit the undersupply to specific periods.

To this end, in one example, a method according to the disclosure comprises the step of resupplying the cell under normal stoichiometric conditions when the current able to be absorbed by the battery or other consumers linked to its terminals becomes greater than a second threshold. This second threshold is preferably at least equal to a current produced by the cell under normal stoichiometric conditions, so as to avoid repeated or unstable switching between normal operation and current-limited operation.

Furthermore, in order to prevent division of the active area, it is advantageous, in one preferred embodiment, to recirculate cathodic gas in order to dilute the residual oxygen homogeneously within the cathode and promote distribution of the current that is produced over the entire active surface area. The recirculation may be performed by way of a pump drawing the gas at the cathode outlet so as to reintroduce it at the inlet. With this provision, it is possible to extend current-limited operation over a period of longer than several minutes, or even continuously.

In another example, a method according to the disclosure comprises the step of turning off the fuel cell and of electrically isolating it by way of contactors if the need to reduce the current that is supplied extends beyond more than 60 seconds, for example.

It should be noted that the disclosure is advantageously able to be implemented in an electric vehicle during recuperative braking phases, in the event that the batteries are too highly charged to accept the addition of the current produced by the fuel cell and of the current originating from the traction motor operating as a generator.

The disclosure also relates to a polymer electrolyte membrane fuel cell system comprising a fuel gas supply circuit linking a fuel gas reservoir to the anode of the fuel cell, and an oxidant gas supply circuit linking an oxidant gas reservoir, or atmospheric air, and comprising control means that make it possible to implement a method according to the disclosure.

The disclosure also relates to a vehicle comprising a system according to the disclosure, and furthermore comprising a voltage generator coupled to the fuel cell.

### BRIEF DESCRIPTION OF THE FIGURES

Other aims and advantages of the disclosure will become clearly apparent in the following description of a preferred, but non-limiting, embodiment, illustrated by the following figures, in which:

FIGS. 1 and 2, already described, show architectures of electric vehicles,

FIG. 3, already described, shows the bias curve of a fuel cell, showing the current of the cell as a function of the voltage,

FIG. 4 shows the map of the current produced by an elementary cell when there is an oversupply of oxygen of 1.8, and

FIG. 5 shows a map of the current produced by an elementary cell when there is an undersupply of oxygen.

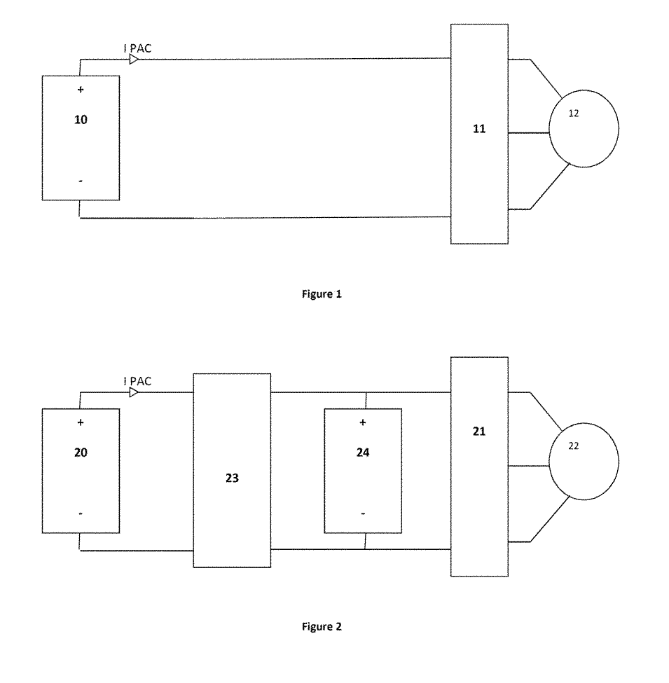

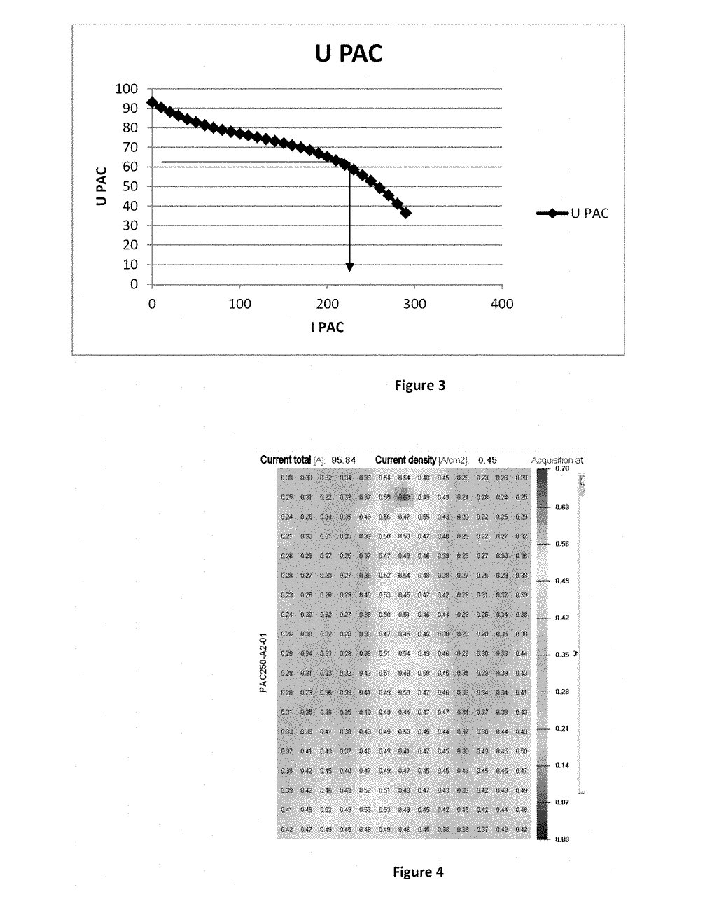

### DESCRIPTION OF THE ENABLING EMBODIMENT

FIG. 4 shows the map of the current measured over the active surface area of an elementary cell of a fuel cell of 200 cm2 by way of a specially developed sensor. In this case, the elementary cell of the fuel cell produces a current of 95 A and is supplied with an air flow rate of 3 standard litres per minute (SLPM). According to the relationship described previously in paragraph [0021], this corresponds to an oversupply of oxygen of 1.8. It is seen that the entire active surface area of the cell contributes to producing current, even if the homogeneity is not perfect.

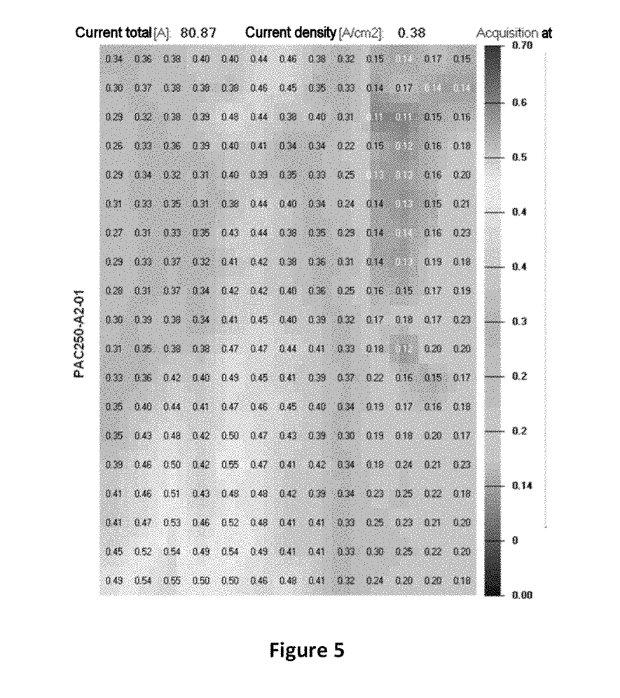

FIG. 5 shows the map of the current produced by the cell of the previous example when the air flow rate is reduced to 1.45 SLPM. This air flow rate does not make it possible to convey the amount of oxygen required to sustain the current established beforehand at 95 A. The current therefore naturally decreases to 80 A, this corresponding, according to the above relationship, to the current that allows practically complete consumption of the oxygen that is provided.

A very large inhomogeneity is seen in the map of the current. Specifically, in the elementary cell tested, the air enters via the upper left-hand corner and is distributed over the surface area of the elementary cell via winding channels, so as to exit via the bottom right-hand corner. As it moves along the winding channels, the air is depleted of oxygen so as to end up approaching an oxygen concentration of zero at the end of the channels. It is for this reason that the right-hand zone of the elementary cell, corresponding to the end of the channels, produces virtually no current.

It is then observed, through these two figures, that the amount of air supplied by the fuel cell has a direct influence on the current that is produced, thereby allowing a method according to the disclosure to effectively control the current produced by the fuel cell.

1. A method for controlling a polymer electrolyte membrane fuel cell, the fuel cell being installed in a system comprising a fuel gas supply circuit linking a fuel gas reservoir to the anode of the fuel cell, and an oxidant gas supply circuit linking an oxidant gas reservoir, or atmospheric air, the method comprising the following steps:
supplying the fuel cell with oxidant gas,
detecting that the current produced by the cell is greater than a first threshold determined on the basis of the system in which the fuel cell is installed, and
reducing the supply of oxidant gas to the fuel cell in order to reduce the current that is produced.

2. The method according to claim 1, the method being implemented in a system furthermore including a battery linked to the fuel cell, and wherein the detection is performed on the basis of the estimation of the charge of the battery.

3. The method according to claim 1, the method being implemented in a system furthermore including a battery linked to the fuel cell, and wherein the detection is performed on the basis of a measurement of the bus current.

4. The method according to claim 1, furthermore comprising the step of resupplying the cell under normal stoichiometric conditions when the current able to be absorbed by the battery or other consumers linked to its terminals becomes greater than a second threshold.

5. The method according to claim 1, further comprising the step of recirculating cathodic gas by drawing gas at the cathode outlet and reinjecting it at the inlet.

6. The method according to claim 1, further furthermore comprising the step of turning off the cell after a predetermined period of undersupplying.

7. A polymer electrolyte membrane fuel cell system comprising a fuel gas supply circuit linking a fuel gas reservoir to the anode of the fuel cell, and an oxidant gas supply circuit linking an oxidant gas reservoir, or atmospheric air, and comprising control means that make it possible to implement a method according to claim 1.

8. The fuel cell system according to claim 7, further comprising a controller installed in the oxidant gas supply circuit, making it possible to control the oxidant gas flow rate.

9. The fuel cell system according to claim 7, further comprising a recirculation pump installed in the oxidant gas supply circuit.

10. A vehicle comprising the fuel cell system according to claim 7, and further comprising a voltage generator coupled to the fuel cell.
